(19) United States
(12) Patent Application Publication
(10) Pub. No.: US 2013/0159267 A1
(43) Pub. Date: Jun. 20, 2013

(54) PROVIDING COMBUSTION SYSTEM MANAGEMENT INFORMATION

(71) Applicants: Jim I. Bartels, Husdon, WI (US); Nathan Longen, White Bear Township, MN (US); Timothy J. Nordberg, Edina, MN (US); Ronald Sorenson, Blaine, MN (US)

(72) Inventors: Jim I. Bartels, Husdon, WI (US); Nathan Longen, White Bear Township, MN (US); Timothy J. Nordberg, Edina, MN (US); Ronald Sorenson, Blaine, MN (US)

(73) Assignee: HONEYWELL INTERNATIONAL INC., Morristown, NJ (US)

(21) Appl. No.: 13/325,941

(22) Filed: Dec. 14, 2011

(51) Int. Cl. G06F 17/30

(52) U.S. Cl. 707/705; 707/E17.01

(57) ABSTRACT

The present disclosure provides methods, devices, and computer readable media for providing combustion system management information. One or more embodiments include receiving a prompt to access management information associated with a combustion system, accessing the management information associated with the combustion system in response to the prompt, and communicating the management information associated with the combustion system.

### TECHNICAL FIELD

The present disclosure relates to methods, devices, and computer readable media for providing combustion system management information.

### BACKGROUND

Installing, operating, and/or maintaining a combustion system can be complex due to the amount of information and/or training that can be associated with the combustion system. Physical documents can be provided that can describe procedures associated with installation, operation, and/or maintenance associated with the combustion system. These physical documents, however, can be: difficult to understand, lost, or located in a place that is not proximate to the combustion system and/or controls of the combustion system. As such, challenges associated with installation, operation, and/or maintenance can arise.

### BRIEF DESCRIPTION OF THE DRAWINGS

FIG. 1 illustrates a method for providing combustion system management information according to one or more embodiments of the present disclosure.

FIG. 2 illustrates a computing device for providing combustion system management information according to one or more embodiments of the present disclosure.

FIG. 3 illustrates an example of computer-readable instructions for providing combustion system management information according to one or more embodiments of the present disclosure.

### DETAILED DESCRIPTION

The present disclosure provides methods, devices, and computer readable media for providing combustion system management information. One or more embodiments include receiving a prompt to access management information associated with a combustion system, accessing the management information associated with the combustion system in response to the prompt, and communicating the management information associated with the combustion system.

Some embodiments of the present disclosure can provide a user with combustion system management information in a way that is readily available to the user. For instance, combustion system management information can be provided on a computing device such that the combustion system management information is located in one place. Some embodiments of the present disclosure can provide combustion system management information in a way that is easy for a user to understand. In an example, combustion system management information can be provided on a computing device in a video, slideshow, audio and/or virtual (i.e., viewable on a display such as a television or computer monitor) document format. Alternatively, and/or in addition, the combustion system management information can provide updated management information based on management actions taken with respect to the combustion system.

In the following detailed description of the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that process, electrical, and/or structural changes may be made without departing from the scope of the present disclosure.

As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate the embodiments of the present disclosure, and should not be taken in a limiting sense.

As used herein, “a” or “a number of” something can refer to one or more such things. For example, “a number of differences” can refer to one or more differences.

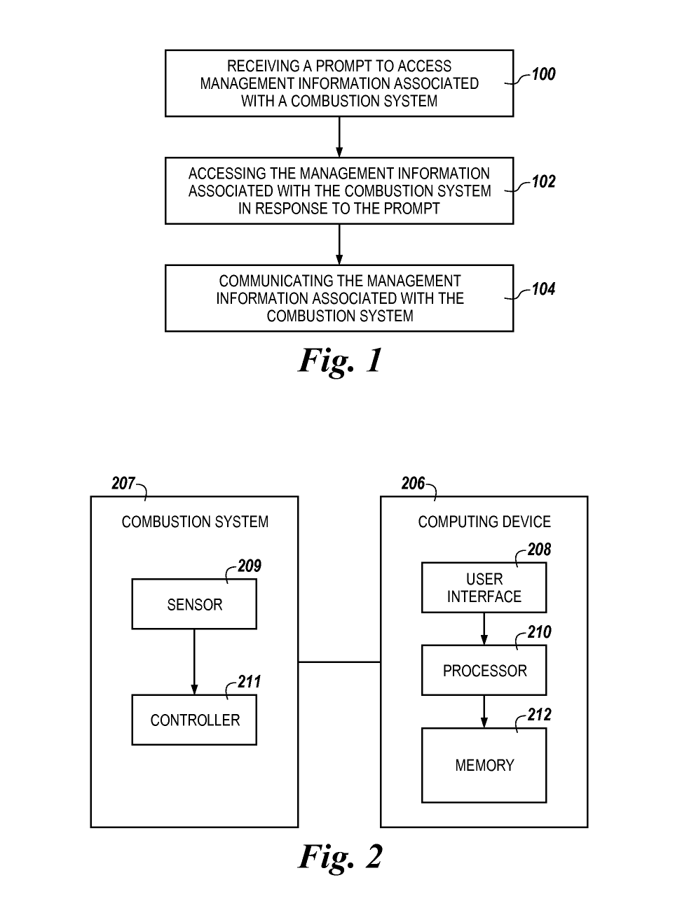

FIG. 1 illustrates a method for providing combustion system management information according to one or more embodiments of the present disclosure. At block 100, the method includes receiving a prompt to access management information associated with a combustion system.

Management information can be defined as information that can be used with regard to installation, operation, and/or maintenance associated with the combustion system. In some embodiments, receiving the prompt to access management information associated with the combustion system can include receiving a manual prompt from a user at a user interface of a computing device (e.g., computing device 206 discussed below in connection with FIG. 2).

For example, a user may make a selection through the user interface to request installation, operation, and/or maintenance information for the combustion system. The request can be received from the user through controls that are coupled to the computing device (e.g., buttons, touch screen, voice recognition system).

In some embodiments, receiving the prompt to access management information can include automatically receiving the prompt based on recognition of a management event associated with the combustion system. In an example, recognition of the management event can be accomplished through placement of sensors on the combustion system.

For example, a temperature sensor may be placed in proximity to the pilot flame, burner flame, and/or electrical heating element of the combustion system. Alternatively, and/or in addition, sensors may be placed on gas and/or electrical lines of the combustion system, for example.

In some embodiments, the management event can include a failure associated with the combustion system. For instance, if the combustion system is a boiler system, a failure may include the pilot light and/or burner of the boiler system being extinguished.

Upon recognition of a management event that includes a failure of the combustion system, instructions can be executed in the computing device, for example, to automatically generate a prompt to access the management information related to the failure from memory in communication with the computing device. In an example, a temperature sensor placed in proximity to the burner of the boiler system may indicate that the burner has been extinguished based on a decreased temperature reading. As a result, a prompt can be automatically generated to access management information, such as a video on how to light the burner and adjust the burner to desired operating specifications.

In some embodiments, the management event can include maintenance associated with the combustion system. In an example, maintenance can include scheduled maintenance and/or maintenance associated with a failure of a portion of the combustion system. For instance, scheduled maintenance can include replacing and/or cleaning a part of the combustion system at a scheduled interval of time, where maintenance associated with a failure of a portion of the combustion system may include replacing and/or cleaning a part of the combustion system as a result of a the failure.

In some embodiments of the present disclosure, upon recognition of a management event that includes maintenance of the combustion system, instructions can be executed in the computing device, for example, to automatically generate a prompt to access the management information related to the maintenance from memory in communication with the computing device. Upon generation of the prompt, the prompt can cause the computing device to access the management information related to the maintenance from memory in communication with the computing device. In an example, a temperature sensor placed in proximity to the burner of the s boiler system may indicate that the burner is not operating at full capacity because of a decreased temperature associated with the burner. As a result, a prompt can be automatically generated to access management information that is related to the management event (e.g., decreased temperature of the burner). The management information can include, for example, a video on how to adjust the burner and/or clean the burner.

In some embodiments, the management event can include an installation associated with the combustion system. In an example, installation can include assembling and/or configuring the combustion system, although examples are not so limited. For instance, installation can include assembling portions of the combustion system, connecting electrical and/or gas connections, and/or configuring the combustion system upon installation.

In some embodiments of the present disclosure, upon recognition of a management event that includes installation of the combustion system, instructions can be executed in the computing device, for example, to automatically generate a prompt to access the management information related to the installation from a memory in communication with the computing device. In an example, a sensor coupled to a gas and/or electrical line can detect the first time that gas and/or electricity is connected to the boiler system. As a result, a prompt can be automatically generated to access management information that is related to the management event (e.g., installation of the boiler system). The management information can include, for example, a video on how to adjust gas flow and/or perform steps associated with the installation.

At block 102, the method includes accessing the management information associated with the combustion system in response to the prompt. In some embodiments, accessing the management information can include accessing management information stored on a computing device mounted at a location proximate to the combustion system and/or controls of the combustion system. By placing the computing device at a location proximate to the combustion system and/or controls of the combustion system, a user of the computing device can have access to the computing device and management information on the computing device when performing management actions.

Management actions can include actions taken with respect to installation, operation, and/or maintenance. For example, a management action can include a user cleaning a burner of a boiler system and/or adjusting a flow of gas to the burner to achieve desired operating parameters, although examples are not so limited.

The method includes communicating the management information associated with the combustion system, at block 104. In some embodiments, communicating the management information associated with the combustion system includes communicating the management information to a display mounted at a location proximate to the combustion system. The management information can, for example, be communicated in a virtual document format (e.g., .pdf, .tif, .jpg), video format (e.g., .avi, .mp4), slideshow format (e.g., .ppt), and/or audio format (e.g., .mp3, .wav) to the display mounted at the location proximate to the combustion system.

In some embodiments, communicating the management information associated with the combustion system includes communicating the management information to a mobile device. The mobile device can be a mobile phone, personal digital assistant, laptop computing device, and/or tablet computing device, although examples are not so limited.

In an example, a recommendation for the management information can be communicated to the mobile device. The recommendation for the management information can cause the mobile device to search for the management information in memory in communication with the mobile device and/or Internet. For example, a recommendation communicated to the mobile device can include information such as, “Boiler Model #123456, Pilot Light Adjustment,” along with instructions to cause the device to search for this information.

In some embodiments, communicating the management information to the mobile device can include communicating management information files to the mobile device. In an example, the video, virtual document, so slideshow, and/or audio file can be communicated to the mobile device.

FIG. 2 illustrates a computing device for providing combustion system management information according to one or more embodiments of the present disclosure. The computing device 206 can be, for example, a desktop computing device, a laptop computing device, or a portable is handheld computing device, such as, for instance, a portable handheld mobile phone, personal digital assistant, media player, or scanner. However, embodiments of the present disclosure are not limited to a particular type of computing device.

As shown in FIG. 2, computing device 206 includes a user interface 208. User interface 208 can be a graphic user interface (GUI) that can provide (e.g., display and/or present) and/or receive information (e.g., data and/or images) to and/or from the user (e.g., operator) of computing device 206. For example, user interface 208 can include a screen that can provide information to the user of computing device 206 and/or receive information entered into a display on the screen (e.g., touch screen) by the user. However, embodiments of the present disclosure are not limited to a particular type of user interface.

As shown in FIG. 2, computing device 206 includes a processor 210 and a memory 212. Memory 212 can be coupled to processor 210. Memory 212 can be volatile or nonvolatile memory. Memory 212 can also be removable (e.g., portable) memory, or non-removable (e.g., internal) memory. For example, memory 212 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disk read-only memory (CD-ROM)), flash memory, a laser disk, a digital versatile disk (DVD) or other optical disk storage, and/or a magnetic medium such as magnetic cassettes, tapes, or disks, among other types of memory.

Further, although memory 212 is illustrated as being located in computing device 206, embodiments of the present disclosure are not so limited. For example, memory 212 can also be located internal to another computing resource (e.g., enabling computer readable instructions to be downloaded over the Internet or another wired or wireless connection).

In some embodiments, memory 212 can store data that includes management information associated with the combustion system. Memory 212 can also store executable instructions, such as, for example, computer readable instructions (e.g., software), for providing combustion system management information in accordance with one or more embodiments of the present disclosure.

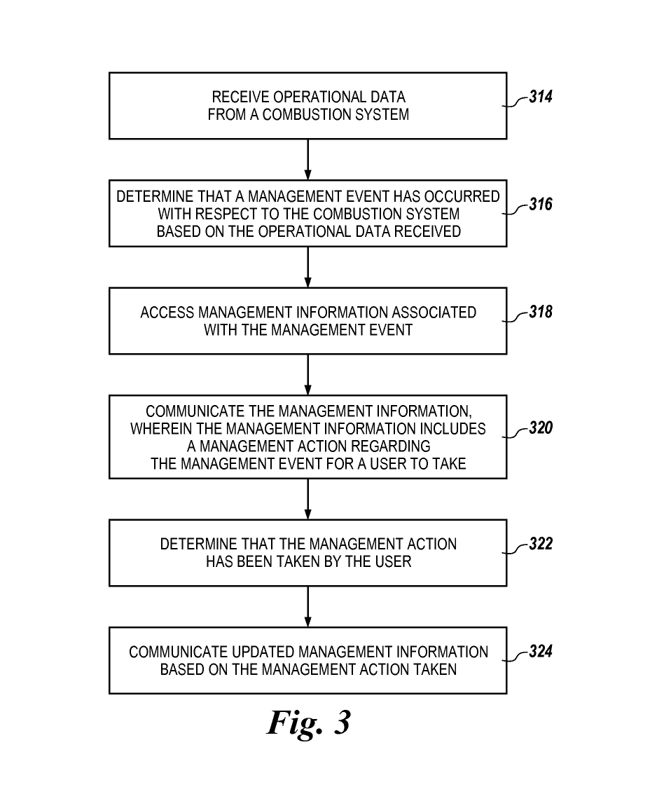

Processor 210 can execute the executable instructions stored in memory 212 to provide combustion system management information in accordance with one or more embodiments of the present disclosure. For example, processor 210 can execute the executable instructions stored in memory 212 to perform one or more of the methods for providing combustion system management information further described herein (e.g., in connection with FIG. 3).

The computing device can determine that a management event associated with the combustion system has occurred. In an example, the computing device 206 can be in communication with combustion system 207. For instance, computing device 206 can be in communication with a sensor 209 that is associated with the combustion system 207, which monitors operational data associated with the combustion system 207. Alternatively, and/or in addition, the computing device 206 may be in communication with a controller 211 associated with the combustion system 207 that monitors operational data associated with the combustion system 207.

In some embodiments, the determination that the management event has occurred can be made by monitoring a signal provided by the sensor 209 and/or controller 211 and received by the computing device 206. Sensor 209 can include sensors such as, for example, a mass flow meter, gas meter, water meter, flow meter, temperature sensor, ammeter, and/or voltmeter, although examples are not so limited.

The computing device 206 can access management information associated with the management event based on the determination that the management event has occurred. In some embodiments, the management information can be accessed from memory 212.

In an example, memory 212 can be external to the computing device, such as a Universal Serial Bus (USB) storage device. The USB storage device can be connected to the computing device 206 through a data port (e.g., USB port). Upon connection of the USB storage device, computing device 206 can access the management information.

The computing device 206 can communicate the management information to a display of the computing device 206. As discussed herein, the management information can be communicated in a virtual document format, video format, slideshow format, and/or audio format.

In some embodiments, the computing device can provide updated management information as a result of a management action taken with respect to the combustion system. In an example, where the computing device is displaying a video on adjusting the burner to suggested operating parameters, the video may tell the user that they need to increase or decrease gas flow based on a previous adjustment they made.

For instance, the computing device 206 may determine, based on sensors associated with the boiler system, that the user has adjusted the gas flow to 100 cubic feet per minute (CFM) based on a signal received from a gas meter and that the burner is operating at a temperature of 700 degrees Fahrenheit (° F.) based on a signal received from a temperature sensor. The computing device can then communicate to the user what needs to be done to attain the suggested operating parameters (e.g., increase the gas flow by 75 CFM to attain a temperature at the burner of 850° F.). This can be communicated to the user through the user interface in one of the various virtual document, video, slideshow, and/or audio formats.

FIG. 3 illustrates an example of computer-readable instructions for providing combustion system management information according to one or more embodiments of the present disclosure. At block 314, instructions can be executed to receive operational data from a combustion system.

As discussed in relation to FIGS. 1 and 2, operational data can be gathered through sensors associated with the combustion system. Instructions can be executed to determine that a management event has occurred with respect to the combustion system based on the operational data received, at block 316.

Instructions can be executed, at 318, to access management information associated with the management event. The management information can be specific to the management event and can be interactive. For example, the management information presented to a user can change based on management actions taken by the user.

At 320, instructions can be executed to communicate the management information. In an example, the management information can include a management action regarding the management event for a user to take. For instance, the management action may include instructions to adjust an operating parameter of the combustion system (e.g., adjust an amount of gas flowing into the burner of the boiler system by a particular amount) to achieve the suggested operating parameters.

Instructions can be executed to determine that the management action has been taken by the user, at 322. In an example, the management information may include instructions directing the user to decrease the flow of gas to the burner of the boiler system. Based on sensors associated with the boiler system (e.g., a sensor coupled to a gas line), a determination can be made based on the signal output by the sensor that the flow of gas has been decreased.

At 324, instructions can be executed to communicate updated management information based on the management action taken. In an example, the updated management information can include an updated management action. For instance, if the user did not decrease the flow of gas to the boiler system by the proper amount, an updated management action can be provided that includes instructions to further adjust the gas flow by an amount.

In some embodiments, instructions can be executed to create a log of what management information has been communicated. In an example, the log can store parameters associated with operation of the combustion system that have been communicated and/or directions associated with operation, maintenance, failures, and/or installation that have been communicated, although examples are not so limited. Alternatively, and/or in addition, the log can store whether the management action has been taken and/or what management action was taken (e.g., gas flow was increased or decreased by an amount). Alternatively, and/or in addition, the log can store the management event.

In some embodiments, the log can be accessed by a user and/or computing device for review of the management information. Alternatively, and/or in addition, the management information can be analyzed by the computing device to determine future management events that will occur with the combustion system. In an example, the computing device can determine future maintenance that will need to be performed on the combustion system as a result of management actions and/or parameters associated with operation of the combustion system. For instance, the computing device can determine that the burner will need to be cleaned over a shorter and/or longer interval of time based on a management action that was taken (e.g., increasing or decreasing the gas flow by an amount, resulting in increased or decreased carbon build up on the burner.)

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

1. A computer implemented method for providing combustion system management information, the method comprising:
receiving a prompt to access management information associated with a combustion system, wherein the management information includes information associated with configuring the combustion system upon installation of the combustion system;
accessing the management information associated with the combustion system in response to the prompt; and
communicating the management information associated with the combustion system.

2. The computer implemented method of claim 1, wherein communicating the management information associated with the combustion system includes communicating the management information to a display mounted at a location proximate to the combustion system.

3. The computer implemented method of claim 1, wherein communicating the management information associated with the combustion system includes communicating the management information to a mobile device.

4. The computer implemented method of claim 3, wherein communicating the management information to the mobile device includes communicating a recommendation for the management information to the mobile device; and
causing the mobile device to search for the management information on the interne based on the recommendation.

5. The method of claim 1, wherein accessing the management information includes accessing management information stored on a computing device mounted at a location proximate to the combustion system.

6. The method of claim 1, wherein receiving a prompt to access management information associated with the combustion system includes receiving a manual prompt from a user.

7. The method of claim 1, wherein communicating the management information associated with the combustion system includes communicating the management information in a video format.

8. The method of claim 1, wherein receiving the prompt to access management information includes automatically receiving the prompt based on recognition of the management event associated with the combustion system.

9. The method of claim 8, further including automatically receiving the prompt based on recognition of a management event that includes a failure associated with the combustion system.

10. The method of claim 8, further including automatically receiving the prompt based on recognition of a management event that includes maintenance associated with the combustion system.

11. A computing device for providing combustion system management information, comprising:
a memory; and
a processor configured to execute executable instructions stored in the memory to;
determine that a management event associated with a combustion system has occurred, wherein the management event is associated with configuring the combustion system upon installation of the combustion system;
access management information associated with the management event based on the determination that the management event has occurred; and
communicate the management information to a display of the computing device.

12. The computing device of claim 11, wherein the computing device is in communication with a sensor that monitors operational data associated with the combustion system.

13. The computing device of claim 12, wherein the determination that the management event has occurred is made by monitoring a signal provided by the sensor.

14. The computing device of claim 11, wherein the management information is in a virtual document format.

15. The computing device of claim 11, wherein the computing device provides updated management information as a result of a management action taken with respect to the combustion system.

16. The computing device of claim 11, wherein the management information is accessed through a data port on the computing device that a storage device has been coupled to.

17. A computer-readable non-transitory medium storing instructions for providing combustion system management information executable by a computer to cause the computer to:
receive operational data from a combustion system;
determine that a management event has occurred with respect to the combustion system based on the operational data received, wherein the management event is associated with configuring the combustion system upon installation of the combustion system;
access management information associated with the management event;
communicate the management information, wherein the management information includes a management action regarding the management event for a user to take;
determine that the management action has been taken by the user; and
communicate updated management information based on the management action taken.

18. The computer-readable non-transitory medium of claim 17, wherein the instructions include instructions to communicate the management information in a slideshow format.

19. The computer-readable non-transitory medium of claim 17, wherein the instructions include instructions to communicate an updated management action.

20. The computer-readable non-transitory medium of claim 19, wherein the instructions include instructions to communicate an updated management action that includes adjusting an operating parameter of the combustion system.
